(19) United States
(12) Patent Application Publication
(10) Pub. No.: US 2007/0120931 A1
(43) Pub. Date: May 31, 2007

(54) METHOD FOR MANUFACTURING SUBSTRATE HAVING THIN FILM PATTERN LAYER

(75) Inventors: YU-NING WANG, Hsinchu (TW); YEN-HUEY HSU, Hsinchu (TW); CHING-YU CHOU, Hsinchu (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF TECHNOLOGY CO., LTD., Hsinchu (TW)

(21) Appl. No.: 11/561,348

(22) Filed: Nov. 17, 2006

(30) Foreign Application Priority Data
Nov. 25, 2005 (TW) 94141497

(51) Int. Cl. B41J 2/01

(52) U.S. Cl. 347/102

(57) ABSTRACT

A method for manufacturing a substrate (10) having a thin film pattern layer (114) thereon includes the steps of: providing a preformed substrate (11) including a number of partition walls with ink repellent characteristic (104) and receiving spaces (106) bounded by the corresponding partition walls; filling the receiving spaces with an ink (112) containing a solidifiable content, wherein the ink received in each of the receiving spaces has a volume greater than that of the corresponding receiving space; and solidifying the ink so that the solidifiable content in the ink is formed into the thin film pattern layer in the receiving space.

### TECHNICAL FIELD

The present invention relates to a method for manufacturing a substrate having a thin film pattern layer thereon.

### BACKGROUND

Currently, thin film patterns are generally manufactured by photolithography technique or an ink jet process.

When the lithography method is adopted, a photo-resist layer is applied on a substrate. A mask is formed in accordance with a shape of partition walls and the photo-resist layer is exposed and developed by using the mask. However, a series of huge machines are necessary to use, a cost of the method is accordingly increased.

Furthermore, referring to FIG. 7, an inkjet process generally includes the steps of: depositing ink into spaces bounded by partition walls 304 on a substrate 300; solidifying the ink to form thin film pattern layer 314.

However, as shown in FIG. 7, the obtained thin film pattern layer 314 have concave surfaces because a contact angle between the ink and the partition walls is small and the ink climb to a higher position in their surrounding parts than in their core parts. As a result, the thin film pattern layer 314 gets a poor evenness in their surfaces, and further treatments are needed to make the surfaces evenness. A manufacturing time is accordingly increased.

What is needed, therefore is to provide a method for manufacturing a substrate having a thin film pattern layer that has high surface evenness.

### SUMMARY

A method for manufacturing a substrate having a thin film pattern layer thereon provided herein generally includes the steps of:

providing a preformed substrate including a plurality of partition walls with ink repellent characteristic and a plurality of receiving spaces bounded by the corresponding partition walls;

filling the receiving spaces with an ink containing a solidifiable content, wherein the ink received in each of the receiving spaces has a volume greater than that of the corresponding receiving space; and

solidifying the ink so that the solidifiable content in the ink is formed into the thin film pattern layer in the corresponding receiving space.

A method for manufacturing a substrate having a thin film pattern layer thereon provided herein generally includes the steps of:

providing a preformed substrate including a plurality of partition walls with ink repellent characteristic and a plurality of receiving spaces bounded by the corresponding partition walls;

filling the receiving spaces with an ink containing a solidifiable content therein in a manner such that the solidifiable content is sufficient to have a volume substantially equal to a volume of the corresponding receiving space, wherein the ink received in each of the receiving spaces has a volume greater than that of the corresponding receiving space; and

solidifying the ink so that the solidifiable content in the ink is formed into the thin film pattern layer in the corresponding receiving space.

A method for manufacturing a substrate having a thin film pattern layer thereon provided herein generally includes the steps of:

providing a preformed substrate including a plurality of partition walls and a plurality of receiving spaces bounded by the corresponding partition walls;

filling the receiving spaces with an ink containing a solidifiable content therein in a manner such that the solidifiable content is sufficient to have a volume substantially equal to a volume of the corresponding receiving space, wherein the ink received in each of the receiving spaces has a volume greater than that of the corresponding receiving space; and

solidifying the ink so that the solidifiable content in the ink is formed into the thin film pattern layer in the corresponding receiving space.

These and other features, aspects, and advantages of the present method will become more apparent from the following detailed description and claims, and the accompanying drawings.

### BRIEF DESCRIPTION OF THE DRAWINGS

Many aspects of the present method for manufacturing a substrate having a thin film pattern layer thereon can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a schematic, sectional view of a preformed substrate having partition walls thereon;

FIG. 2 to FIG. 3 are schematically showing a method for manufacturing the preformed substrate shown in FIG. 1;

FIG. 4 to FIG. 6 are schematically showing a method for manufacturing a substrate having thin film pattern layer by using the preformed substrate shown in FIG. 1; and

FIG. 7 is a schematic, sectional view of a conventional substrate having thin film pattern layer thereon.

### DETAILED DESCRIPTION OF THE PREFERRED EMBODIMENTS

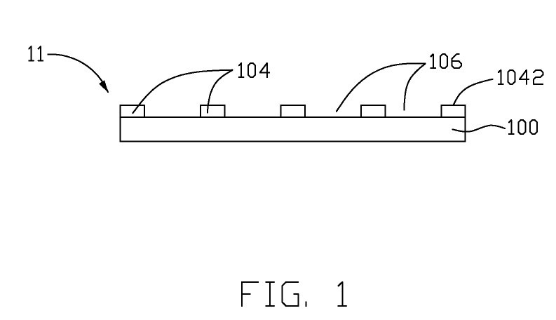

Referring to FIGS. 1 to 6, a method for manufacturing a substrate 10 having a thin film pattern layer 114 (e.g. colorant layers) thereon is hereby provided. The method includes the steps of: providing a preformed substrate 11 including a plurality of partition walls 104 with ink repellent characteristic and receiving spaces 106 bounded by the corresponding partition walls 104; filling the receiving spaces 106 with ink 112 (e.g. a colorant solution) containing a solidifiable content and the ink received in each of the receiving spaces has a volume greater than that of the corresponding receiving space.; and soildifying the ink 112 so that the solidifiable content in the ink 112 forming the thin film pattern layer 114 in the receiving space 106.

Referring to FIG. 1, a provided preformed substrate 11 includes a substrate 100, a plurality of partition walls 104 with ink repellent characteristic formed thereon, and receiving spaces 106 bounded by the partition walls 104. The partition walls 104 are arranged in a predetermined pattern, and advantageously have substantially flat top surfaces 1042. The receiving spaces 106 are defined by the partition walls 104. The neighboring partition walls 104 are separated by one of the receiving spaces 106. The substrate is generally made of glass, quartz glass, silicon, metal, or polymer resin. Further, the partition walls 104 are generally made of polymer resin. Otherwise, the partition walls 104 may be made of black resin or the like to function as black matrixes.

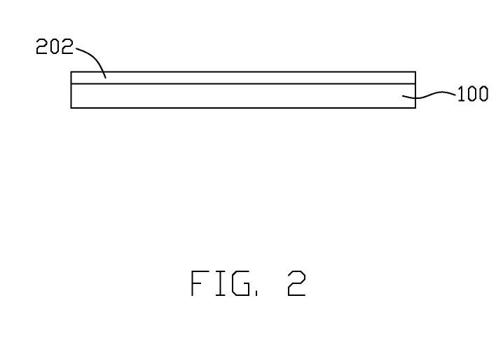

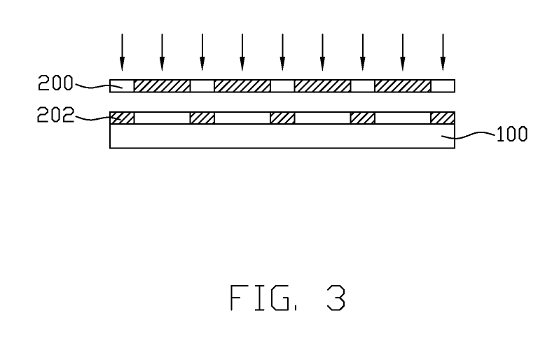

Referring to FIGS. 2 and 3, a method for manufacturing the preformed substrate 11 generally includes the following steps: providing the substrate 100; applying a photo-resist layer 202 on the substrate 100; exposing the photo-resist layer by using a photo mask 200; and developing the photo-resist layer 202 to form the plurality of partition walls 104.

In this embodiment, the photo-resist layer 202 is made of a negative photo-resist material. Alternatively, a positive photo-resist material can be used but the design of the mask is difference. The photo-resist layer 202 is formed on the substrate 100 by a certain process, such as spin coating, spray coating, rolling coating, die coating, dip coating, bar coating, slit coating and the like. The photo mask 200 is formed corresponding to the predetermined pattern of the partition walls 104. The photo-resist layer 202 is exposed by using the photo mask 200 and is developed. Accordingly, the partition walls 104 are formed on the substrate 100 in the predetermined pattern. The partition walls 104 may be composed by single layer or multiple layers. For example, a lower layer is made of inorganic material and an upper layer is made of organic material.

Alternatively, the preformed substrate 11 may be manufactured by deposition molding. Accordingly, the substrate 100 and the partition walls 104 are integrally formed.

The partition walls 104 should have appropriate ink repellent characteristic. For example, a contact angle between the ink 112 received in each of the receiving spaces 106 and the corresponding partition wall 104 should be larger than about 15 degrees and less than about 90 degrees, preferably, larger than 20 degrees and less than about 65 degrees. Accordingly, in this range the ink 112 can be more likely to be confined in the receiving spaces 106 without influence the wetting ability of the substrate 100.

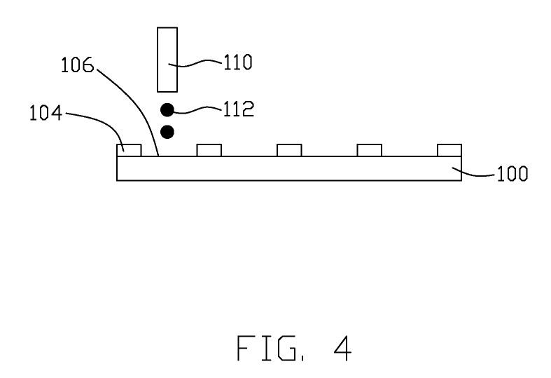

Referring to FIG. 4, the ink 112 is deposited in the receiving space 106 by using a dispenser 110. In this embodiment, the dispenser is an ink jet apparatus, such as a thermal ink jet apparatus, a piezoelectric ink jet apparatus, and the like.

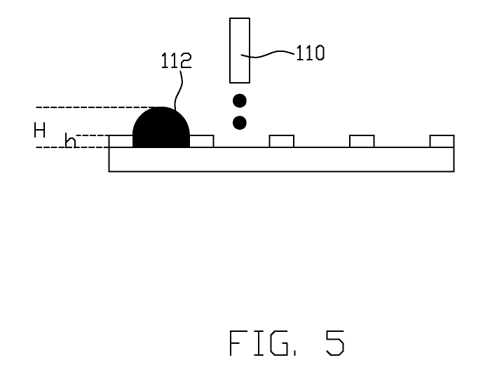

Referring to FIG. 5, the receiving space 106 is deposited with the sufficient ink 112 such that a solidifiable content of the ink 112 received in the receiving space 106 may have a volume roughly equal to a volume of the corresponding receiving space 106 to achieve a better uniformity. Then, the neighboring receiving space 106 is deposited with the ink 112. Normally, the volume of solidifiable content of the ink 112 is roughly equal means that a proportion of a volume to the volume of the corresponding receiving space 106 is in the range from about 65% to about 135%, more preferably, in the range from about 80% to about 120%. One of ideal cases is that the solidifiable content is sufficient to have a volume substantially equal to a volume of the corresponding receiving space 106 from uniformity consideration.

The ink 112 deposited in the receiving space 106 has a convex top surface over the receiving space 106 due to surface tension of the ink 112. Accordingly, the ink 112 deposited in the receiving space 106 has a greater volume than that of the receiving space 106. The volume of the receiving space 106 is generally calculated by a surface area of the substrate 100 exposed in the receiving space 106 times a height h of the partition wall 104. In fact, the volume of the ink 112 deposited in the receiving space 106 may be determined in accordance with a volume percent of the solidifiable content in the ink 112. For example, if the volume percent of the solidifiable content in the ink 112 is about 33%, the volume of the ink 112 deposited in the receiving space 106 should be roughly three times greater than that of the receiving space 106. The ink 112 has a height H roughly three times greater than the height h of the partition wall 104.

The receiving spaces 106 can be deposited with the ink 112 one by one, or be deposited with the ink 112 at the same time by using a plurality of ink jet heads. Furthermore, the receiving spaces 106 can be deposited with different inks, for example, red, green, and blue inks, if desired.

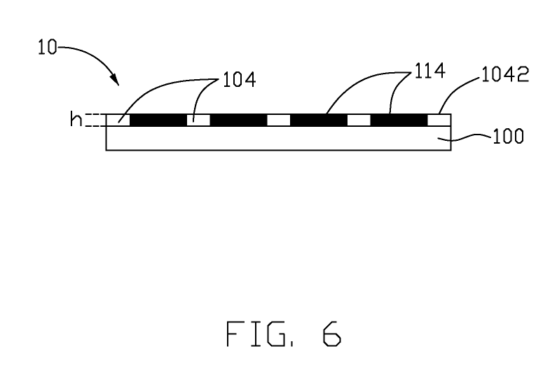

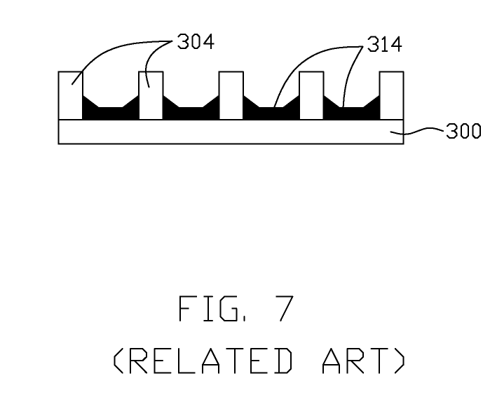

Referring to FIG. 6, the ink 112 deposited in the receiving spaces 106 are solidified to form the thin film pattern layer 114 by a heating device, a vacuum pump, a light exposure device, or any of their combinations. Thereby, the thin film pattern layer 114 is substantially flush with the top surfaces 1042 of the partition walls 104. Most solvent of the ink 112 is thereby evaporated, and the solidifiable content in the ink 112 is remained in the receiving space 106.

Accordingly, a volume of the thin film pattern layer 114 in the receiving space 106 is equal to or less than that of the solidifiable content in the ink 112 in the same position after ink is solidified. The volume may be is less due to the density change in solidifying process. Since a proportion of a volume of solidifiable content of the ink 112 to the volume of the corresponding receiving space 106 is in the range from about 65% to about 135%, more preferably, in the range from about 80% to about 120%. Therefore, a proportion of the volume of the thin film pattern layer 114 in the receiving space 106 to the volume of the corresponding receiving space 106 is in the range from about 50% to about 135%. Preferably, a proportion of the volume of the thin film pattern layer 114 in the receiving space 106 to a volume of the corresponding receiving space 106 is in the range from 70% to 120%. Also, the thin film pattern layer 114 has a thickness roughly equal to a height of the partition walls 104. The proportion of a thickness of the thin film pattern layer 114 to a height of the partition walls 104 is in the range from about 50% to about 135%, more preferably, in the range from about 70% to about 120%.

The thin film pattern layer 114 has even surfaces, and has a height roughly equal to the height h of the partition walls 104. Generally, no more processes are needed to treat the surface of the thin film pattern layer 114 to obtain a high even degree of the surface. As a result, a manufacturing time is shortened.

The substrate 10 is used for a color filter, organic emission device. Moreover, if desired, the partition walls 104 can be partially removed from the substrate 100.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A method for manufacturing a substrate having a thin film pattern layer thereon, the method comprising the steps of:
providing a preformed substrate including a plurality of partition walls with ink repellent characteristic and a plurality of receiving spaces bounded by the corresponding partition walls;
filling the receiving spaces with an ink containing a solidifiable content, wherein the ink received in each of the receiving spaces has a volume greater than a volume of the corresponding receiving space ; and
solidifying the ink so that the solidifiable content in the ink is formed into the thin film pattern layer in the corresponding receiving space.

2. The method according to claim 1, wherein the volume of the solidifiable content in the ink is less than the half of the volume of the ink.

3. The method according to claim 1, wherein the ink received in each of the receiving spaces has a volume at least two times greater than the volume of the corresponding receiving space.

4. The method according to claim 1, wherein the preformed substrate is manufactured by the following steps:
providing a substrate;
applying a photo-resist layer on the substrate;
exposing the photo-resist layer using a photo mask; and
developing the photo-resist layer to form the plurality of partition walls.

5. The method according to claim 1, wherein the preformed substrate is manufactured by deposition molding.

6. The method according to claim 1, wherein the ink is applied in the receiving spaces using an inkjet apparatus.

7. The method according to claim 6, wherein the ink jet apparatus is a thermal ink jet apparatus or a piezoelectric ink jet apparatus.

8. The method according to claim 1, wherein the ink is solidified by at least one device selected from the group consisting of a heating device, a vacuum pump, and a light exposure device.

9. The method according to claim 1, wherein the ink deposited in each of the receiving spaces has a convex top surface over the corresponding receiving space.

10. The method according to claim 1, further comprising a step of partially removing the partition walls from the substrate after solidifying the ink.

11. The method according to claim 1, wherein a proportion of a volume of solidifiable content of the ink to the volume of the corresponding receiving space is in the range from about 65% to about 135%.

12. The method according to claim 1, wherein a proportion of a volume of solidifiable content of the ink to the volume of the corresponding receiving space is in the range from about 80% to about 120%.

13. The method according to claim 1, wherein a proportion of a volume of the thin film pattern layer to the volume of the corresponding receiving space is in the range from about 50% to about 135%.

14. The method according to claim 1, wherein a proportion of a volume of the thin film pattern layer to the volume of the corresponding receiving space is in the range from about 70% to about 120%.

15. The method according to claim 1, wherein a proportion of a thickness of the thin film pattern layer to a height of the corresponding partition wall is in the range from about 50% to about 135%.

16. The method according to claim 1, wherein a proportion of a thickness of the thin film pattern layer to a height of the corresponding partition wall is in the range from about 70% to about 120%.

17. The method according to claim 1, wherein a contanct angle between the ink received in each of the receiving spaces and the corresponding partition wall is greater than about 15 degrees and less than about 90 degrees for achieving the ink repellent characteristic of the partition walls.

18. The method according to claim 1, wherein a contanct angle between the ink received in each of the receiving spaces and the corresponding partition wall is greater than about 20 degrees and less than about 65 degrees for achieving the ink repellent characteristic of the partition walls.

19. The method according to claim 1, wherein the partition walls are composed of a single layer or multiple layers.

20. A method for manufacturing a substrate having a thin film pattern layer thereon, the method comprising the steps of:
providing a preformed substrate including a plurality of partition walls and a plurality of receiving spaces bounded by the corresponding partition walls;
filling the receiving spaces with an ink containing a solidifiable content therein in a manner such that the solidifiable content is sufficient to have a volume substantially equal to a volume of the corresponding receiving space, wherein the ink received in each of the receiving spaces has a volume greater than a volume of the corresponding receiving space; and
solidifying the ink so that the solidifiable content in the ink is formed into the thin film pattern layer in the corresponding receiving space.

21. The method according to claim 20, wherein the volume of the solidifiable content in the ink is less than the half of the volume of the ink.

22. The method according to claim 20, wherein the ink received in each of the receiving spaces has a volume at least two times greater than the volume of the corresponding receiving space.

23. The method according to claim 20, wherein the preformed substrate is manufactured by the following steps:
providing a substrate;
applying a photo-resist layer on the substrate;
exposing the photo-resist layer using a photo mask; and
developing the photo-resist layer to form the plurality of partition walls.

24. The method according to claim 20, wherein the preformed substrate is manufactured by deposition molding.

25. The method according to claim 20, wherein the ink is applied in the receiving spaces using an ink jet apparatus selected from the group consisting of a thermal ink jet apparatus or a piezoelectric ink jet apparatus.

26. The method according to claim 20, wherein the ink is solidified by at least one device selected from the group consisting of a heating device, a vacuum pump, and a light exposure device.

27. The method according to claim 20, wherein the ink in each of the receiving spaces has a convex top surface over the corresponding receiving space.

28. The method according to claim 20, further comprising a step of partially removing the partition walls from the substrate after solidifying the ink.

29. The method according to claim 20, wherein a proportion of a volume of the thin film pattern layer to a volume of the corresponding receiving space is in the range from about 50% to about 135%.

30. The method according to claim 20, wherein a proportion of a volume of the thin film pattern layer to a volume of the corresponding receiving space is in the range from about 70% to about 120%.

31. The method according to claim 20, wherein a proportion of a thickness of the thin film pattern layer to a height of the corresponding partition wall is in the range from about 50% to about 135%.

32. The method according to claim 20, wherein a proportion of a thickness of the thin film pattern layer to a height of the corresponding partition wall is in the range from about 70% to about 120%.

33. A method for manufacturing a substrate having a thin film pattern layer thereon, the method comprising the steps of:
providing a preformed substrate including a plurality of partition walls having ink repellent characteristic associated therewith and a plurality of receiving spaces bounded by the corresponding partition walls;
filling the receiving spaces with an ink containing a solidifiable content therein in a manner such that the solidifiable content is sufficient to have a volume substantially equal to a volume of the corresponding receiving space, wherein the ink received in each of the receiving spaces has a volume greater than a volume of the corresponding receiving space; and
solidifying the ink so that the solidifiable content in the ink is formed into the thin film pattern layer in the corresponding receiving space.
